(19) United States
(12) Patent Application Publication
(10) Pub. No.: US 2024/0344532 A1
(43) Pub. Date: Oct. 17, 2024

(54) HYDRAULIC POWER UNIT FOR MATERIAL TESTING

(71) Applicant: Illinois Tool Works Inc., Glenview, IL (US)

(72) Inventor: Steven Robert SQUIRES, Bicester, England (GB)

(21) Appl. No.: 18/292,667

(22) PCT Filed: Jul. 29, 2022
(86) PCT No.: PCT/US2022/038880

§ 371 Date: Jan. 26, 2024

(30) Foreign Application Priority Data
Aug. 5, 2021 (GB) 2111330.3

(51) Int. Cl. F15B 1/26

(52) U.S. Cl. CPC F15B 1/26; F15B 2211/20515; F15B 2211/20546; F15B 2211/6309; F15B 2211/6651

(57) ABSTRACT

According to an embodiment of the present disclosure, there is provided a hydraulic power unit, HPU, for providing a pressurised hydraulic fluid to a material testing apparatus, the HPU comprising: a reservoir for storing a hydraulic fluid; a pump for pumping the hydraulic fluid to an outlet connectable to the material testing apparatus; an alternating current, AC, electric motor arranged to drive the pump, wherein the electric motor is located within the reservoir; and an electrical inverter for providing an AC electrical supply to the electric motor, wherein the electrical inverter is arranged to control an operating point of the electric motor.

### BACKGROUND

Servo-hydraulic material testing machines (also sometimes known as structural tests machines) are used to test the physical characteristics of a material sample by utilising a hydraulic actuator to apply a test force to the material sample. The hydraulic actuator is driven by a hydraulic power unit which is typically arranged to provide pressurised hydraulic fluid to the material testing machine.

However, existing hydraulic power units used for material testing applications operate inefficiently and give rise to an excessively high power consumption.

It is an object of the present disclosure to at least mitigate one or more of the problems of the prior art.

### BRIEF SUMMARY OF THE DISCLOSURE

In accordance with the present disclosure, there is provided a method of controlling a hydraulic power unit, HPU, for providing a pressurised hydraulic fluid to a material testing apparatus, the HPU having an electric motor and a pump, the method comprising: controlling a pressure of the pressurised hydraulic fluid based on a first pressure set point for performing a first material test process; receiving an indication of a second pressure set point for a second material test process to be performed by the material testing apparatus; and controlling the pressure of the pressurised hydraulic fluid based on the second pressure set point for performing the second material test process.

Optionally, the second pressure set point is less than the first pressure set point.

Optionally, controlling the pressure (e.g., based on one or both of the first and second pressure set points) comprises controlling a rotational speed of the electric motor.

Optionally, controlling the rotational speed of the electric motor comprises reducing the rotational speed of the electric motor such that an energy consumption of the electric motor is reduced in dependence on the second pressure set point.

Optionally, controlling the pressure (e.g., based on one or both of the first and second pressure set points) comprises controlling a fluid displacement of the pump.

Optionally, controlling the fluid displacement of the pump comprises reducing the fluid displacement of the pump such that an energy consumption of the electric motor is reduced in dependence on the second pressure set point.

Optionally, controlling the pressure (e.g., based on one or both of the first and second pressure set points) comprises controlling both a fluid displacement of the pump and a rotational speed of the electric motor; wherein one or both of the fluid displacement of the pump and the rotational speed of the electric motor are controlled in dependence on predetermined characterisation data, such that a combined operating efficiency of the electric motor and the pump is controlled.

Optionally, the method further comprises: determining a flow rate of hydraulic fluid flowing through the pump and controlling one or both of the fluid displacement of the pump and the rotational speed of the electric motor in dependence thereon; wherein the predetermined characterisation data is indicative of one or both of a target fluid displacement of the pump and a target rotational speed of the electric motor depending on the said flow rate.

Optionally, the method further comprises controlling the fluid displacement of the pump in dependence on the target fluid displacement.

Optionally, the method further comprises controlling the rotational speed of the electric motor in dependence on the target rotational speed.

Optionally, the indication of the second pressure set point is determined in dependence on a user-input received at a user interface.

Optionally, the indication of the second pressure set point is determined by a controller of the material testing apparatus.

Optionally, the indication of the second pressure set point is determined by a remote computing device communicatively couplable to a communications network, and wherein receiving the indication comprises receiving the indication from the server via the communications network.

Optionally, the indication of the second pressure set point is based on a prediction of a load demand for the second material test process.

Optionally, the prediction of the load demand for the second material test process is a prediction of a maximum load demand.

According to an embodiment of the present disclosure, there is provided a method comprising: obtaining an indication of a test configuration of a material test process to be performed by a material testing apparatus, the material testing apparatus arranged to receive a pressurised hydraulic fluid from a hydraulic power unit, HPU; determining a load demand of the material test process based on the received indication of the test configuration; and providing an indication of a pressure set point to a controller based on the determined load demand, the controller arranged to control a pressure of the pressurised hydraulic fluid for performing the material test process.

Optionally, the test configuration comprises one or both of a material composition of a sample corresponding to the material test process, and one or more test parameters.

Optionally, the load demand is a maximum load demand.

Optionally, determining the load demand of the material test process comprises predicting the load demand based on the obtained indication of the test configuration.

Optionally, the method further comprises: predicting the load demand of the material test process based on (e.g., obtained) (e.g., result) data corresponding to a plurality of previous material test processes.

Optionally, the method further comprises obtaining the (e.g., result) data corresponding to a plurality of previous material test processes.

Optionally, the data comprises respective indications of a (e.g., maximum) load demand for a plurality of previous material test processes, each previous material test process having a respective test configuration.

Optionally, the load demand of the material test process is predicted based on a machine learning model, the machine learning model being trained based on the data corresponding to the plurality of previous material test processes.

According to an embodiment of the present disclosure, there is provided machine-readable instructions which when executed by processing circuitry cause the processing circuitry to perform a method according to any method above.

According to an embodiment of the present disclosure, there is provided a computer program product comprising the above machine-readable instructions.

According to an embodiment of the present disclosure, there is provided a (e.g., non-transitory) computer readable medium comprising the above machine-readable instructions.

According to an embodiment of the present disclosure, there is provided a controller for controlling a hydraulic power unit, HPU, having an electric motor and a pump, the HPU arranged to provide a pressurised hydraulic fluid to a material testing apparatus, the controller arranged to: control a pressure of the pressurised hydraulic fluid based on a first pressure set point for performing a first material test process; receive an indication of a second pressure set point for a second material test process to be performed by the material testing apparatus; and control the pressure of the pressurised hydraulic fluid based on the second pressure set point for performing the second material test process

According to an embodiment of the present disclosure, there is provided a hydraulic power unit, HPU, comprising a controller in accordance with any controller above.

According to an embodiment of the present disclosure, there is provided a system comprising a hydraulic power unit in accordance with the above hydraulic power unit; and a material testing apparatus arranged to receive a pressurised hydraulic fluid from the hydraulic power unit.

According to an embodiment of the present disclosure, there is provided an apparatus arranged to: obtain an indication of a test configuration of a material test process to be performed by a material testing apparatus; determine a load demand of the test process based on the obtained indication of the test configuration; and provide an indication of a pressure set point to a controller based on the determined load demand, the controller arranged to control a pressure of the pressurised hydraulic fluid for performing the material test process.

According to an embodiment of the present disclosure, there is provided a hydraulic power unit, HPU, for providing a pressurised hydraulic fluid to a material testing apparatus, the HPU comprising: a reservoir for storing a hydraulic fluid; a pump for pumping the hydraulic fluid to an outlet connectable to the material testing apparatus; an alternating current, AC, electric motor arranged to drive the pump, wherein the electric motor is located within the reservoir; and an electrical inverter for providing an AC electrical supply to the electric motor, wherein the electrical inverter is arranged to control an operating point of the electric motor. Optionally, the HPU is arranged to provide the hydraulic fluid to the outlet at a target pressure.

Optionally, the HPU is arranged to provide the hydraulic fluid to the outlet at a target pressure.

Optionally, the target pressure is set based on a received signal.

Optionally, the electrical inverter is arranged to control the operating point of the electric motor by controlling any one or more of: a voltage of the AC electrical supply; a current of the AC electrical supply; a frequency of the AC electrical supply; and a phase of the AC electrical supply.

Optionally, the electrical inverter is arranged to control the operating point of the electric motor by controlling one or more of the current of the AC electrical supply, the frequency of the AC electrical supply, and the phase of the AC electrical supply such that an operating efficiency of the electric motor is changed to maintain the operating point.

Optionally, the pump is a variable displacement pump to control a flow rate of the hydraulic fluid from the outlet.

Optionally, the HPU comprises a controller arranged to control a rotational speed of the electric motor to maintain the hydraulic fluid at the outlet at the target pressure.

Optionally, the controller has an input for receiving a pressure signal indicative of the target pressure.

Optionally, the controller has a first output for providing a motor control signal to the electrical inverter for controlling the rotational speed of the electric motor.

Optionally, the motor control signal is indicative of one or more parameters of the AC electrical supply.

Optionally, the motor control signal is indicative of the target pressure.

Optionally, the controller is arranged to control a fluid displacement of the pump to maintain the hydraulic fluid at the outlet at the target pressure.

Optionally, the controller has a second output for providing a pump control signal to the pump for controlling the fluid displacement of the pump.

Optionally, the pump control signal is indicative of a target displacement of the pump.

Optionally, the pump control signal is indicative of the target pressure.

Optionally, the pump is operable as a pressure compensated variable displacement pump having an adjustable pressure set point, wherein the controller is arranged to control the fluid displacement of the pump by controlling the said adjustable pressure set point.

Optionally, the controller is arranged to control both the speed of the electric motor and the fluid displacement of the pump; wherein one or both of the fluid displacement of the pump and the rotational speed of the electric motor are controlled in dependence on predetermined characterisation data, such that a combined operating efficiency of the electric motor and the pump is controlled.

Optionally, the controller is arranged to: determine a flow rate of hydraulic fluid flowing through the pump and control one or both of the fluid displacement of the pump and the rotational speed of the electric motor in dependence thereon; wherein the predetermined characterisation data is indicative of one or both of a target fluid displacement of the pump and a target rotational speed of the electric motor depending on the said flow rate.

Optionally, the controller is arranged to control the fluid displacement of the pump based on the target fluid displacement.

Optionally, the controller is arranged to control the rotational speed of the electric motor based on the target rotational speed.

Optionally, the electric motor is arranged to be, in use, submerged within the hydraulic fluid within the reservoir.

Optionally, the pump is located within the reservoir.

Optionally, the pump is arranged to be, in use, submerged within the hydraulic fluid within the reservoir.

Optionally, the HPU comprises a cooling pump arranged within the reservoir, wherein the motor is arranged to drive the cooling pump to pump the hydraulic fluid to a cooling apparatus external to the hydraulic power unit.

Optionally, the cooling pump is arranged to be, in use, submerged within the hydraulic fluid within the reservoir.

According to an embodiment of the present disclosure, there is provided a system comprising: any HPU above; and a material testing apparatus arranged to receive a pressurised hydraulic fluid from the HPU.

### BRIEF DESCRIPTION OF THE DRAWINGS

Embodiments of the disclosure will now be described by way of example only, with reference to the accompanying figures, in which:

FIG. 1 schematically illustrates an example system comprising a hydraulic power unit and a material testing apparatus, in accordance with an embodiment of the present disclosure;

FIG. 2 schematically illustrates an example hydraulic power unit in accordance with an embodiment of the present disclosure;

FIG. 3 schematically illustrates another example hydraulic power unit in accordance with an embodiment of the present disclosure.

FIG. 4 schematically illustrates another example hydraulic power unit in accordance with an embodiment of the present disclosure.

FIG. 5 schematically illustrates another example hydraulic power unit in accordance with an embodiment of the present disclosure.

FIG. 6 schematically illustrates an example apparatus in accordance with various embodiments of the present disclosure;

FIG. 7 is an example flowchart schematically illustrating a method according to an embodiment of the present disclosure; and

FIG. 8 is another example flowchart schematically illustrating a method according to an embodiment of the present disclosure.

### DETAILED DESCRIPTION

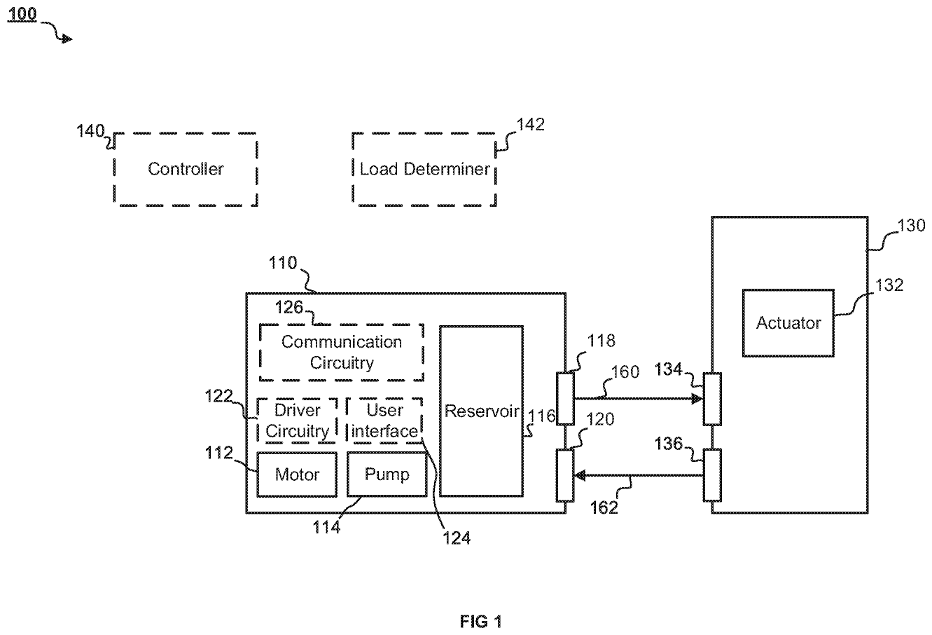

FIG. 1 schematically illustrates an example system 100 according to an embodiment of the present disclosure. The system 100 may provide for testing the physical characteristics of a material sample. The material sample may be, for example, a sample of a material produced by a production process, and testing its physical characteristics may enable, for example, the quality of the production process to be assessed.

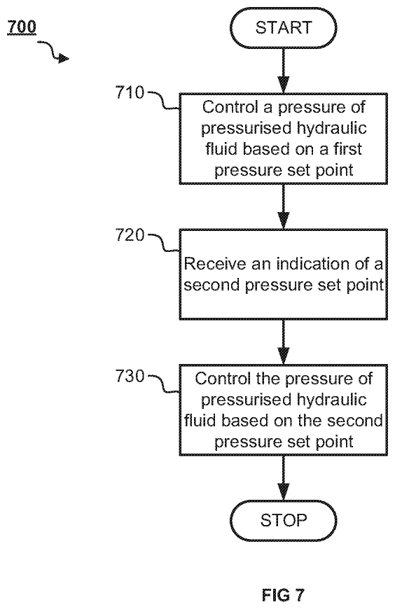

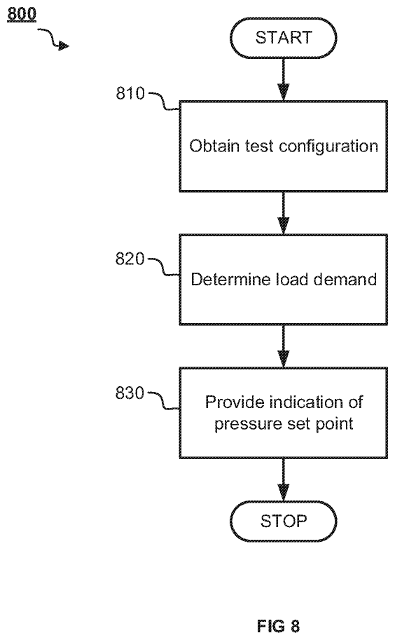

The system 100 comprises a hydraulic power unit (HPU) 110 (which may also be referred to as a hydraulic power pack) and a (e.g., servo-hydraulic) material testing apparatus 130. Optionally, the system 100 further comprises one or both of a controller 140 and a load determiner 142. In some examples, the controller 140 may be configured to perform a method according to an embodiment of the present disclosure, as described below in relation to FIG. 7. In some examples, the load determiner 142 may be configured to perform a method according to an embodiment of the present disclosure, as described below in relation to FIG. 8.

The material testing apparatus 130 is arranged to, using hydraulic actuation means, perform one or more material test processes to exert one or both of a force and a torque along one or more axes of the material sample which may enable the physical properties of the material sample to be assessed.

A material test process may comprise, for example, any type of mechanical or physical material test. In some examples, a material test process may depend on one or more corresponding test parameters which may, for example, indicate how (e.g., with respect to one or more axes of the material sample) one or more test variables are to be controlled in accordance with the material test process.

In some examples, the one or more test variables may comprise any one or more of: a (e.g., linear or rotational) actuation displacement; an actuation force; an actuation torque; a strain induced in the material sample; and a temperature of the material sample (which may e.g., result from self-heating of the material sample).

In some examples, the material test process may comprise, for example, any type of material test process wherein e.g., any one or more test variables, such as the test variable described above, are controlled. In some examples, the material test process may include, for example, any one or more of: a fatigue test including a high cycle fatigue test (wherein, for example, one or both of the actuation force and the actuation displacement may be controlled), a low cycle fatigue test (wherein, for example, the strain induced in the material sample may be controlled), and a composite fatigue test (wherein for example, the actuation force and the temperature of the material sample may be controlled); a crack propagation test (wherein, for example, the actuation force may be controlled); a fracture toughness test (wherein, for example, one or both of the actuation displacement and the actuation force may be controlled); a biaxial test (wherein, for example, the (e.g., linear) actuation displacement or the actuation force along a first axis of the material sample may be controlled, and wherein the (e.g., rotational) actuation force or the actuation torque along a second axis, orthogonal to the first axis, of the material sample may be controlled); a variable amplitude (spectrum) loading test (wherein, for example, the actuation force may be controlled); a static test (wherein for example, any one or more of the following may be controlled: the actuation displacement, the actuation force, and the strain induced in the material sample); and any other type of mechanical or physical test including but not limited to a stress test, a tensile test, a compression test, a torsion test, and a strain test.

The HPU 110 is connectable to the material testing apparatus 130 and may be arranged to, in use, provide a pressurised hydraulic fluid to the material testing apparatus 130 to enable performance of one or more material test processes by the material testing apparatus 130.

The HPU 110 comprises an electric motor 112, a pump 114, a reservoir 116, an outlet 118 (which may be known as “pressure”), and an inlet 120 (which may be known as “return”). Optionally, as will be discussed further below, the HPU 110 may further comprise any one or more of: motor driver circuitry 122; a user interface 124; and communication circuitry 126.

The electric motor 112 is arranged to drive the pump 114, and the pump 114 is arranged to pump a hydraulic fluid from the reservoir 116, which is arranged to store the hydraulic fluid, to the outlet 118 to thereby provide a pressurised hydraulic fluid to the outlet 118. The outlet 118 of the HPU 110 may be arranged to provide the pressurised hydraulic fluid to the inlet 134 of the material testing apparatus 130 via fluidic coupling means, such as one or more pipes, as indicted by the arrow 160. The inlet 120 of the HPU 110 may be arranged to receive a hydraulic fluid from the outlet 136 of the material testing apparatus 130 via fluidic coupling means, as indicated by the arrow 162. The inlet 120 of the HPU 110 may receive the hydraulic fluid from the outlet 136 of the material testing apparatus 130 for example, subsequent to the said hydraulic fluid having flown through and having been utilised by the hydraulic actuation means of the material testing apparatus 130, for example, during performance of a material test process. The inlet 120 of the HPU 110 may be further arranged to return the received hydraulic fluid to the reservoir 116.

Unless otherwise stated, the electric motor 112 may comprise any type of electric motor including, for example: any type of alternating current (AC) electric motor including, for example, any AC electric motor having any number of phases, such as 1 phase or 3 phases, for example; any type of direct current (DC) electric motor; and any other type of electric motor.

In some examples, the HPU 110 may optionally comprise the motor driver circuitry 122 which may be arranged to provide an electrical supply to the electric motor 112 in accordance with the present technique. In some examples where the electric motor 112 comprises a 3 phase AC electric motor and where the motor driver circuitry 122 is not present, the HPU 110 may optionally comprise start circuitry (such as, for example, a star delta starter, or any other type of start circuitry) (not shown) arranged to control the electric motor 112 during start up.

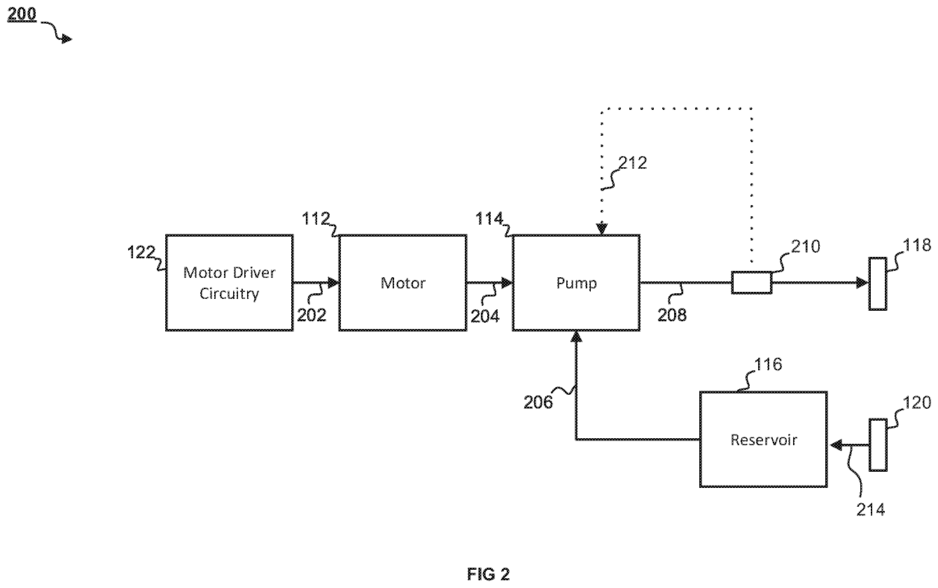

In some examples, the motor driver circuitry 122 may be arranged to control a rotational speed of the electric motor 112 in accordance with the present technique. As will be discussed further below in relation to FIGS. 2 to 5, in some examples, the motor driver circuitry 122 may be controlled by the controller 140 to control the rotational speed of the electric motor 112 so as to control an output pressure of the HPU 110 based on a (e.g., selectively adjustable) pressure set point (e.g., to maintain an output pressure of the HPU 110 at a target pressure, the target pressure based on the pressure set point e.g., the target pressure being equal to or greater than the pressure set point). As used herein, the output pressure of the HPU 110 is used to refer to a pressure of the pressurised hydraulic fluid provided to the outlet 118 of the HPU 110 which may substantially correspond to the a pressure of the pressurised hydraulic fluid provided to the material testing apparatus 130.

In some examples, the motor driver circuitry 122 may comprise controlling means (not shown) operable to receive an indication of the pressure set point and to control the output pressure of the HPU 110 based on the pressure set point by controlling the rotational speed of the electric motor 112. The said controlling means may be integrated within the motor driver circuitry 122 or may be external to the motor driver circuitry 122 and operably coupled therewith. The said controlling means may comprise, for example: electronic controlling means comprising processing circuitry operable to implement a control algorithm, such as, for example a proportional-integral-derivative (PID) based control algorithm, or any other type of control algorithm; or any other type of controlling means. In some examples, the said controlling means of the motor driver circuitry 122 may be operable to control the output pressure of the HPU 110 based on both the pressure set point and an indication of a measured output pressure of the HPU 110, the measured output pressure being provided by e.g., a pressure sensor (not shown) or any other type of sensor operable to measure one or more metrics indicative of the output pressure of the HPU 110. In other words, the said controlling means may be arranged to implement closed-loop control based on feedback comprising the indication of the output pressure of the HPU 110. In other examples, as will be discussed further below, the controller 140 may implement a functionality of the controlling means discussed immediately above.

In some examples, the rotational speed of the electric motor 112 may be controlled in accordance with the present technique by providing a motor control signal (not shown) to the motor driver circuitry 122. In examples where the motor driver circuitry 122 comprise controlling means such as those discussed above, the motor control signal may comprise, for example, an indication of the pressure set point. Alternatively, in other examples, the motor control signal may comprise, for example, an indication of one or more parameters of the electrical supply to be provided to the electric motor 112 by the motor driver circuitry 122.

The motor driver circuitry 122 may depend on the type of the electric motor 112. For example, in examples where the electric motor 112 is an AC electric motor, the motor driver circuitry 124 may comprise an electrical inverter (which may also be referred to as, for example, a variable frequency drive, an AC drive, or a variable speed drive). In these examples, the electrical supply to be provided to the electric motor 112 by the motor driver circuitry may be an AC electrical supply. The electrical inverter may be arranged to control any one or more of: a voltage of the said AC electrical supply; a current of the said AC electrical supply; a frequency of the said AC electrical supply; and a phase of the said AC electrical supply.

In examples where the electric motor 112 is a DC motor, the motor driver circuitry 122 may comprise, for example, a half bridge motor driver, a full bridge motor driver, or any other type of driver circuitry suitable for driving a DC motor at variable rotational speeds. In the these examples, the electrical supply to be provided to the electric motor 112 may comprise a pulse width modulated DC electrical supply, and the motor driver circuitry 122 may be arranged to control, for example, a pulse width modulation (PWM) duty cycle of the electrical supply.

It has been observed that existing systems used for material testing purposes typically operate an electric motor of a HPU in an inefficient and wasteful manner, thereby giving rise to an excessively high power consumption of the HPU. Advantageously, as will be discussed further below, in some embodiments, the present disclosure provides for an HPU having an AC electric motor, an operating point of which is controlled by an electrical inverter, which may, in some examples, enable the AC electric motor to have an improved operating efficiency.

In some examples, the motor driver circuitry 122 comprising the electrical inverter may be arranged to control an operating point of the electric motor 112. As will be understood, the operating point of the electric motor may refer to a rotational speed-output torque point at which the electric motor 112 is operating. The operating point may correspond to an intersection of a torque-speed curve of the electric motor 112 and a torque-speed curve of the system driven by the electric motor 112 e.g., the pump 114 in dependence of corresponding hydraulic circuitry fluidically coupled thereto. By controlling one or more parameters of the (AC) electrical supply, the motor driver circuitry 122 comprising the electrical inverter may be operable to control the torque-speed curve of with the electric motor 112 and thereby control its operating point for a given torque-speed curve of the system.

In some examples, motor driver circuitry 122 comprising the electrical inverter may be arranged to control the operating point of the electric motor 112 by controlling one or more parameters of the (AC) electrical supply such that an operating efficiency of the electric motor 112 is changed to maintain the operating point. The operating efficiency of the electric motor may depend on a ratio of an input power (e.g., power provided to the electric motor 112) to an output power (e.g., power provided to the load). The output power may depend on the operating point of the electric motor 112. For a given operating point of the electric motor 112, the motor driver circuitry 122 comprising the electrical inverter may be arranged to control one or more parameters of the (AC) electrical supply provided to the electric motor 112 so as to maintain the operating point, and therefore, the output power, and to reduce the input power, thereby increasing the operating efficiency of the electric motor 112 for that operating point. To do so, the motor driver circuitry 122 comprising the electrical inverter may control for example, one or more parameters of the AC electrical supply so as to reduce power losses associated with the electric motor 112 (e.g., copper losses in the stator and rotor windings of the electric motor 112, or any other losses). In changing the operating efficiency to maintain the operating point, the electrical inverter may use any type of control technique, including for example, so-called scalar control, so-called vector control, or any other type of control technique. The electrical inverter may utilise open-loop control or closed-loop control based on feedback provided by one or more sensors (not shown) operable to measure one or more metrics indicative of the operating point of the electric motor 112.

Unless otherwise stated, the pump 114 may comprise any type of pump including, for example, any type of pump operable to turn mechanical or electrical energy into fluid power. In some examples, the pump 114 may comprise any one of a: non-positive displacement pump, such as, for example, a centrifugal pump, or any other type of non-positive displacement pump; a positive displacement pump; and any other type of pump.

In examples wherein the pump 114 comprises a positive displacement pump, the pump 114 may comprise, for example, any one of: a reciprocating pump, a rotary pump, an external gear pump, an internal gear pump, a lobe pump, a gerotor pump, any other type of gear pump, a screw pump, a vane pump, a piston pump including an axial piston pump and a radial piston pump, or any other type of positive-displacement pump. In some examples, the pump 114 may comprise or be otherwise operable as a fixed displacement pump where a fluid displacement—the volume of fluid displaced per pump cycle—is fixed. Alternatively, the pump 114 may be a variable displacement pump where the fluid displacement may be controllable. As an illustrative example, the pump 114 may comprise an axial variable displacement pump having an adjustable swash plate, an angle of which may be adjusted to control the fluid displacement of the pump 114. This is merely one example of a variable displacement pump, however, and the present disclosure is not so limited.

In examples wherein the pump 114 is a variable displacement pump, the pump 114 may be operable as a pressure compensated variable displacement pump arranged to control its fluid displacement to regulate its output pressure to substantially correspond to a pressure set point. The pressure set point may be fixed or adjustable. In some examples, the pump 114 may be arranged to receive an indication of the pressure set point to set the pressure set point of the pump 114.

In examples wherein the pump 114 is a variable displacement pump, the pump 114 may comprise pressure compensating controlling means (not shown) operable to control the output pressure of the HPU 110 based on the pressure set point by controlling the fluid displacement of the pump 114. The pressure compensating controlling means may be integrated within the pump 114 or may be external to the pump 114 and operably coupled therewith. The pressure compensating controlling means may comprise, for example: hydraulic controlling means, such as, for example, a pressure compensated valve; mechanical controlling means; electronic controlling means; any combination thereof; or any other type of controlling means. In some examples, the pressure compensated controlling means may control the fluid displacement of the pump 114 based on a fixed pressure set point. In other examples, the pressure compensated controlling means may be arranged to receive an indication of the pressure set point and control the fluid displacement of the pump 114 based on the received indication. In some examples, the pressure compensating controlling means may comprise, for example electronic controlling means comprising processing circuitry operable to implement a control algorithm, such as, for example a proportional-integral-derivative (PID) based control algorithm, or any other type of control algorithm. In some examples, the pressure compensating controlling means may control the output pressure of the HPU 110 based on both the pressure set point and an indication of a measured output pressure of the HPU 110, the measured output pressure being provided by e.g., a pressure sensor (not shown) or any other type of sensor operable to measure one or more metrics indicative of the output pressure of the HPU 110. In some examples, the pressure sensor may be integrated within the pump 114. In other examples, the pressure sensor may be external to the pump 114 and operably coupled to the pressure compensating controlling means thereof.

In some examples, as will be discussed further below, the controller 140 may implement a functionality of the pressure compensating controlling means discussed above.

In examples wherein the pump 114 is a variable displacement pump, the fluid displacement of the pump 114 may be controlled in accordance with the present technique by providing a pump control signal to the pump 114. In examples where the pump 114 comprises pressure compensating controlling means such as those discussed above, the pump control signal may comprise, for example, an indication of the pressure set point. Alternatively, in other examples, the pump control signal may comprise, for example, an indication of the fluid displacement of the pump 114.

In some examples, one or both of the electric motor 112 and the pump 114 may be located within the reservoir 116 (not shown). In these examples, at least in use, the one or both of the electric motor 112 and the pump 114 may be at least partially submerged in hydraulic fluid stored in the reservoir 116. In these examples, the hydraulic fluid stored in the reservoir 116 may at least partially attenuate acoustic noise generated by the one or both of the electric motor 112 and the pump 114. Advantageously, these examples may provide for a comparatively quiet HPU (e.g., without the use of expensive acoustic cladding) which may beneficially enable the HPU to be tolerably located in the same room as the material testing apparatus 130, which may circumvent the use of, for example, hydraulic infrastructure to locate the HPU in a separate room from the material testing apparatus 130. Furthermore, the hydraulic fluid stored in the reservoir 116 may provide thermal cooling for the one or both of the electric motor 112 and the pump 114. Such thermal cooling may be particularly effective, for example, in examples where the hydraulic fluid is actively cooled as described below.

In some examples, the HPU 110 may optionally comprise a cooling pump (not shown). The cooling pump may be arranged within the reservoir 116. The electric motor 112 may be arranged to drive the cooling pump to pump the hydraulic fluid to a cooling apparatus external to the HPU 110 (not shown). In these examples, at least in use, the cooling pump may be at least partially submerged in hydraulic fluid stored in the reservoir 116 which may advantageously provide similar benefits to those discussed above in relation to the electric motor 112 and the pump 114.

Referring back to the system 100 generally, the material testing apparatus 130 comprises a hydraulic actuator 132, the inlet 134, and the outlet 136.

The hydraulic actuator 132 may be arranged to exert one or both of a force and a torque along one or more axes of a material sample for a material test process.

The hydraulic actuator 132 may comprise any type of hydraulic actuator, including, for example: a linear hydraulic actuator including but not limited to a hydraulic cylinder; a rotary hydraulic actuator; a hydraulic motor; a biaxial hydraulic actuator; any other type of hydraulic actuator; and any combination thereof. In some examples, the hydraulic actuator 132 of the material testing apparatus 130 may be arranged to operate at below 10 MN, below 5 MN or in a force range of 10 kN to 5 MN, although other force ranges may be possible. The inlet 134 of the material testing apparatus 130 may be arranged to receive the pressurised hydraulic fluid from the outlet 118 of the HPU 110 via fluidic coupling means, as indicated by the arrow 160. The inlet 134 of the material testing apparatus 130 may be further arranged to provide at least some of the pressured hydraulic fluid received from the outlet 118 of the HPU 110 to the hydraulic actuator 132 to enable testing of the material sample in accordance with the material test process. The outlet 136 of the material testing apparatus 130 may be arranged to provide hydraulic fluid to the outlet 120 of the HPU via fluidic coupling means, as indicated by the arrow 162. The outlet 136 of the material testing apparatus 130 may provide the hydraulic fluid to the outlet 120, for example, subsequent to the said hydraulic fluid having flown through and having been utilised by the hydraulic actuator 132 of the material testing apparatus 130.

It has been observed that existing systems used for material testing purposes typically utilise a HPU having an electric motor and a pump, where, for a given load, the electric motor and the pump are operated in an inefficient manner such that a combined operating efficiency of the electric motor and the pump is non-optimal or inefficient for the given load.

Furthermore, the HPU of such existing systems is typically arranged to provide pressurised hydraulic fluid to a material testing apparatus at a fixed (i.e., non-adjustable) output pressure irrespective of a pressure demand of a material test process to be performed. In such systems, a pressure of hydraulic fluid originating from the HPU may be adjusted by the material testing apparatus downstream of the HPU in order to meet the pressure demand of a given material test process.

Accordingly, in circumstances where the fixed output pressure of an HPU of such existing systems exceeds the pressure demand of a given material test process, such a HPU may needlessly and wastefully pressurise hydraulic fluid at its output beyond what is required to successfully perform the material test process. Furthermore, in such circumstances, to meet requirements of the material test process, it may be required to reduce the pressure of the hydraulic fluid output by the HPU downstream of the HPU (e.g., using a pressure relief valve), with which there may a further associated energy cost e.g., it may be required to implement a cooling system having an associated energy consumption required to dispose of heat in hydraulic fluid e.g., having been expelled by the pressure relief valve. Accordingly, existing solutions are inefficient and give rise to an excessively high power consumption, particularly when performing material test processes having a pressure demand (e.g., substantially) lower than an output pressure of the HPU.

Advantageously, as will be discussed further below, the present disclosure provides for an HPU having an electric motor and a pump arranged to provide pressurised hydraulic fluid to a material testing apparatus, where one or both of the electric motor and the pump can be controlled to improve their operating efficiency while maintaining a target HPU output pressure. Furthermore, the output pressure of the HPU may be controllable and may be tailored to meet the pressure demands of a particular material test process, thereby providing a more efficient HPU for material testing purposes.

Returning to FIG. 1, in some examples the system 100 may comprise the controller 140, which may be arranged to control the output pressure of the HPU 110 in accordance with the present technique.

In some examples, the controller 140 may be arranged to control the output pressure of the HPU 110 based on a (e.g., selectively adjustable) pressure set point. For example, the controller 140 may be arranged to maintain the output pressure of the HPU 110 at a target pressure, the target pressure being based on the pressure set point (e.g., the target pressure being equal to or greater than the pressure set point).

In some examples, the controller 140 may have a first input (not shown) arranged to receive (e.g., a signal comprising) an indication of the pressure set point. Additionally or alternately, as will be discussed further below in relation to FIGS. 2 to 5, the controller 140 may have a second input (not shown) arranged to receive (e.g., a signal comprising) an indication of a measured output pressure of the HPU 110.

As will be discussed further below, the indication of the pressure set point may be determined based on a test configuration of a material test process to be performed by the material testing apparatus 130. In some examples, the said determination may comprise a prediction of a (e.g., maximum) load demand for the material test process. The indication of the pressure set point may be received from, for example: a user interface such as the user interface 124 of the HPU 110 or any other user interface communicatively couplable with the controller 140, including but not limited to a user interface associated with the material testing apparatus 130; an apparatus such as, for example, the load determiner 142; a computing device, including for example, a computing device associated with the material testing apparatus 130 (e.g., a controller of the material testing apparatus 130), or a remote computing device communicatively couplable to the controller 140.

In some examples, the indication of the pressure set point may correspond to a (e.g., default) pressure set point with respect to the material test process. In some examples, a computing device may determine the indication of the pressure set point, for example, based on the material test process. For example, the computing device may have access to a memory (which may be comprised within the computing device or communicatively coupled thereto) arranged to store one or more (e.g., default) indications of pressure set points depending on respective test configurations, and the computing device may determine the indication of the pressure set point by obtaining it from the memory. In some examples, the computing device may be associated with (e.g., comprised within or communicatively coupled to e.g., a controller of) the material testing apparatus 130. In other examples, the computing device may comprise a remote computing device communicatively couplable to the controller 140 via a communications network (not shown), such as, for example, a Local Area Network (LAN) or a Wide Area Network (WAN). The communications network may be wired or wireless or a combination of wired and wireless.

In some examples, the indication of the pressure set point may comprise, for example, a value of the pressure set point, or any other value based thereon or otherwise indicative of the pressure set point. In some examples, the indication of the pressure set point may comprise, for example, an indication of a force demand (e.g., of the hydraulic actuator 132 of the material testing apparatus 130 for a material test process). In these examples, the controller 140 may be arranged to convert the force demand to the pressure set point (e.g., determine the pressure set point based on the force demand) using any suitable method or technique. In some examples, the controller 140 may convert the force demand to the pressure set point based on, for example, predetermined hydraulic actuator characterisation data. The predetermined hydraulic actuator characterisation data may be indicative of a relationship between an input pressure (e.g., of hydraulic fluid provided to the hydraulic actuator 132) and a force output by the hydraulic actuator 132. For example, the hydraulic actuator characterisation data may be indicative of a first actuation force of the hydraulic actuator 132 for a first input pressure. In these examples, the force demand may be converted to the pressure set point by scaling the first input pressure based on a ratio of the force demand to the first actuation force. As an illustrative example, the first actuation force may correspond to a full-scale force capacity of the hydraulic actuator 132 (e.g., 100 kN) and the first input pressure may correspond to a maximum rated input pressure (e.g., 210 Bar). If the force demand were, for example, half of the full-scale force capacity of the hydraulic actuator 132 (e.g., 50 kN), the force demand may be converted to a corresponding pressure set point by scaling the maximum rated input pressure by a factor of a half (e.g., to give a pressure set point of 105 Bar). This is merely one illustrative example, however, and the present disclosure is not so limited. In some examples, the predetermined hydraulic actuator characterisation data may be indicative of any given actuation force of the hydraulic actuator 132 for any corresponding input pressure, and the force demand may be any value in relation to the said given actuation force. In other examples, the predetermined hydraulic characterisation data may comprise any other data indicative of a relationship between an input pressure and a force output by the hydraulic actuator 132.

In some examples, a similar conversion process to that described above may be utilised to convert a pressure demand to a force demand. In other examples, any other method or technique may be used to convert a force demand to a pressure demand (or set point) or vice versa.

In some examples, the controller 140 may be arranged to control the rotational speed of the electric motor 112 to control the output pressure of the HPU 110 based on the pressure set point. In these examples, the controller 140 may have a first output (not shown) arranged to provide the above-described motor control signal to the motor driver circuitry 122 to control the rotational speed of the electric motor 112 accordingly.

In examples wherein the pump 114 comprises a variable displacement pump, the controller 140 may be arranged to control the fluid displacement of the pump 114 to control the output pressure of the HPU 110 based on the pressure set point. In these examples, the controller 140 may have a second output (not shown) arranged to provide the above-described pump control signal to the pump 114 to control the fluid displacement of the pump 114 accordingly.

In examples wherein the pump 114 comprises a variable displacement pump, the controller 140 may be arranged to control both the rotational speed of the electric motor 112 (e.g., via the motor control signal) and the fluid displacement of the pump 114 (e.g., via the pump control signal) to control the output pressure of the HPU 110 based on the pressure set point. In these examples, the controller 140 may be arranged to control one or both of the fluid displacement of the pump 114 and the rotational speed of the electric motor 112 in dependence on predetermined characterisation data, such that a combined operating efficiency of the electric motor 112 and the pump 114 is controlled.

The predetermined characterisation data may be indicative of, for example, a target fluid displacement of the pump 114 in dependence of a flow rate of the hydraulic fluid flowing through pump (e.g., provided to the outlet 118). Additionally or alternatively, the predetermined characterisation data may be indicative of, for example, a target rotational speed of the electric motor 112 in dependence of the said flow rate. The target fluid displacement and the target rotational speed may provide for a given flow rate while enabling the combined operating efficiency of the electric motor 112 and the pump 114 to be substantially optimised for that flow rate. The predetermined characterisation data may be based on, for example, characterisation measurements of the pump 114 and the electric motor 112 or modelling of the pump 114 and the electric motor 112, or via any other method.

In some examples, the controller 140 may be arranged to determine a flow rate of hydraulic fluid flowing through the pump 114 and to control one or both of the fluid displacement of the pump 114 and the rotational speed of the electric motor 112 in dependence of the said determined flow rate. The flow rate may be determined in any manner. For example, the flow rate may be measured using any type of flow rate sensor (not shown). In other examples, the flow rate may be inferred based on other parameters indicative of the flow rate which may be measured or otherwise known, including, for example, the rotational speed of the electric motor 112 and the fluid displacement of the pump 114.

In some examples, the controller 140 may be arranged to control one or both of the fluid displacement of the pump 114 and the rotational speed of the electric motor 112 based on the predetermined characterisation data and the determined flow rate. In some examples, the controller 140 may be arranged to control the fluid displacement of the pump 114 based on the above-described target fluid displacement indicated by the characterisation data. Additionally or alternatively, the controller 140 may be arranged to control the rotational speed of the electric motor 112 based on the above-described target rotational speed indicated by the characterisation data.

In some examples, the controller 140 may be arranged to: control the output pressure of the HPU 110 based on a first pressure set point for performing a first material test process (e.g., maintain the output pressure of the HPU at a first target pressure, the first target pressure based on the first pressure set point e.g., the first target pressure being equal to or greater than the first pressure set point); receive an indication of a second pressure set point for a second material test process to be performed by the material testing apparatus 130; and control the output pressure of the HPU 110 based on the second pressure set point (e.g., substantially maintain the output pressure of the HPU at a second target pressure, the second target pressure based on the second pressure set point e.g., the second target pressure being equal to or greater than the second pressure set point).

In some examples, the first pressure set point may correspond to or be otherwise based on e.g., a default pressure set point where, for example, the HPU 110 is arranged to control based on the default pressure set point when first powered on or e.g., an indication of the first set point previously received by the controller 140.

In some examples, the second pressure set point may be less than the first pressure set point. Accordingly, controlling the output pressure of the HPU 110 based on the second pressure set point may reduce an energy consumption of the HPU 110 in comparison to controlling the output pressure of the HPU 110 based on the first pressure set point.

Controlling the output pressure of the HPU 110 based on the first pressure set point, may comprise any method of controlling an output pressure of an HPU based on a pressure set point, including, for example, any method of controlling an output pressure of the HPU 110 based on the above-described pressure set point disclosed herein. Similarly, controlling the output pressure of the HPU 110 based on the second pressure set point, may comprise any method of controlling an output pressure of an HPU based on a pressure set point, including, for example, any method of controlling the output pressure of the HPU 110 based on the above-described pressure set point disclosed herein.

The controller 140 may be implemented in any of hardware, software, firmware, or any combination thereof. In some examples, the controller 140 may comprise processing circuitry, such as, for example, a microcontroller, a programmable logic controller, or any other type of processing circuitry.

Referring back the system 100 generally, the system 100 may comprise the load determiner 142, which may be arranged to determine a load demand of a material test process to be performed by the material testing apparatus 130 and to enable the HPU 110 to control its output pressure based on the determined load demand. As used herein, the load demand of a material test process may correspond to, for example: a pressure demand (e.g., of the pressurised hydraulic fluid to be provided to the material testing apparatus 130) for the material test process; or a force demand (e.g., of the hydraulic actuator 132) for the material test process.

In some examples, the load determiner 142 may be arranged to: obtain an indication of a test configuration of a material test process to be performed by a material testing apparatus; determine a load demand of the test process based on the received indication of the material test configuration; and provide an indication of a pressure set point to the controller 140 based on the determined load demand. The load demand may correspond to, for example, a maximum load demand for the material test process e.g., the highest pressure or e.g., the highest actuation force that that material test process could require to be performed successfully. In other words, the load demand may be indicative of at least a minimum output pressure of the HPU 110 required for the material test process to be performed successfully. The indication of the pressure set point may comprise, for example, a value of the pressure set point, or any other value based thereon or otherwise indicative of the pressure set point, including, for example, an indication of the force demand.

In some examples, a test configuration may comprise, any one or more of a material composition of a material test sample, and one or more test parameters, which may, for example, indicate how one or more test variables, including but not limited to any test variables disclosed herein, are to be controlled in accordance with the material test process.

In some examples, the load determiner 142 may have an input (not shown) arranged to receive a signal comprising an indication of the test configuration for the material test process. The indication of the test configuration for the test process may be received from, for example: a user interface such as the user interface 128 of the HPU 110 or any other user interface communicatively couplable with the load determiner 142; a computing device, including for example, a computing device associated with the material testing apparatus 130 such as, for example, any computing device associated with the material testing 130 apparatus disclosed herein, a remote computing device, including, for example, any remote computing device disclosed herein, or any other computing device.

In some examples, the load determiner 142 may have an output (not shown) arranged to provide a signal comprising the indication of the pressure set point to the controller 140.

In some examples, the material test process may correspond to a so-called force-control test process wherein an actuation force of the hydraulic actuator 132 of the material testing apparatus 130 is a controlled variable. In these examples, the force demand may be known, and therefore, the load demand for that material test process may be determinable from the test configuration alone.

In some examples, actuation force may not be a controlled variable of the material test process. For example the material test process may correspond to a so-called strain-control test, or any other type of test process where actuation force is not a controlled variable. In these examples, the load demand of the material test process, may depend on, for example, the material composition of the material sample being tested or the test parameters. In these examples, the load demand may be determined based on result data corresponding to a previous test having the same test configuration, the result data comprising an indication of the load demand for that test configuration. In other examples, the load demand may be predicted based on the test configuration. For example, the load demand may be predicted based on result data corresponding to one or more previous test processes. The result data may comprise, for example, respective indications of a (e.g., maximum) load demand for each of the one or more previous test processes, each test process having a respective test configuration.

In some examples, the result data may correspond to one or more test processes having respective test configurations which differ from the obtained test configuration. In these examples, the load demand for the test configuration may be determined based on the result data and a difference or differences between the obtained test configuration and the test configuration(s) of the result data.

As an illustrative example, the obtained test configuration may comprise a first material composition and first test parameters and the result data may comprise data corresponding to a previous test configuration comprising the first test parameters but a second material composition, the second material composition being different from the first. Based on the first test parameters and the differences between the first and second material compositions, the load demand for the obtained test configuration may be predicted. For example, it may be known or determined (e.g., via modelling) how the differences between the first and second material compositions affect the physical properties of the material sample, and the load demand may be predicted based thereon. This is merely one illustrative example, however, and the present disclosure is not so limited.

In some examples, the load demand of obtained test configuration may be predicted based on a machine learning model (such as, for example, a neural network), the machine learning model being trained based on result data comprising respective indications of a (e.g., maximum) load demand for a plurality of previous test processes, each previous test process having a respective test configuration. In these examples, the load determiner 142 may comprise the trained machine learning model. In some examples, the load determiner 142 may be arranged to train the machine learning model. In other examples, the machine learning model may be trained by a computing device communicatively coupled to the load determiner 142, including but not limited to any computing device disclosed herein.

In some examples the load determiner 142 may obtain the data (e.g., the result data) from a memory accessible by the load determiner 142. The memory may be comprised within the load determiner 142 or may be external to the load determiner 142 and communicatively coupled therewith. The memory may be, for example, comprised within any computing device disclosed herein. In some examples, the load determiner 142 may be operable to convert a pressure demand to a force demand or vice versa in accordance with any examples disclosed herein.

The load determiner 142 may be implemented in any of hardware, software, firmware, or any combination thereof. In some examples, the load determiner 142 may comprise processing circuitry, such as, for example, a microcontroller, a programmable logic controller, or any other type of processing circuitry.

Referring back to the system 100 generally, while the controller 140 and the load determiner 142 are shown in FIG. 1 to be separate from the HPU 110 and the material testing apparatus 130, this is merely one illustrative example and the present disclosure is not so limited. In some examples, the HPU 110 may comprise one or both of the controller 140 and the load determiner 142. In other examples, one or both of the controller 140 and the load determiner 142 may be external to and communicatively couplable with the HPU 110. For example, one or both of the controller 140 and the load determiner 142 may be implemented by one or more computing devices. In some examples, one or more of the said one or more computing devices may be local to the HPU 110 and directly couplable with the HPU 110, for example, by wired or wireless communication means in accordance with any communication standard including, but not limited to a controller area network (CAN) bus standard, a universal serial bus (USB) standard, a Bluetooth standard, a Wi-Fi direct standard, or any other type of communication standard. In some examples, one or more of the said one or more computing devices may be comprised within or associated (e.g., communicatively couplable) with the material testing apparatus 130. For example, one or more of the said one or more computing devices may be arranged to control the material testing apparatus to perform a test process. Such a computing device may, for example, be arranged to store one or more (e.g., default) pressure set points depending on respective test configurations. In some examples, one or more of the said one or more computing devices may be a remote computing device communicatively couplable with the HPU 110 over, for example, a communications network (not shown), such as, for example, a Local Area Network (LAN) or a Wide Area Network (WAN). The communications network may be wired or wireless or a combination of wired and wireless.

In examples where the HPU 110 comprises the controller 140, the communications circuitry 126 may be arranged to receive the indication of the pressure set point and provide the indication of the pressure set point to the controller 140.

In examples where the controller 140 is external to the HPU 110, the communications circuitry 126 may be arranged to receive, for example, an indication of the above-described pump control signal and to provide it to the pump 114. Additionally or alternatively, in some examples, communications circuitry 126 may be arranged to receive the above-described motor control signal from the controller 140 and to provide it to the motor driver circuitry 122.

FIGS. 2 to 5 schematically illustrate example hydraulic power units in accordance with various embodiments of the present disclosure. The example hydraulic power units shown in FIGS. 2 to 5 may correspond to, for example, the HPU 110 shown in FIG. 1. Thus, the above description of the HPU 110 is also applicable to the example hydraulic power units shown FIGS. 2 to 5. The same reference numerals are used for corresponding features of FIG. 1 and FIGS. 2 to 5. For the sake of simplicity, the user interface 124 and the communication circuitry 126 have been omitted from FIGS. 2 to 5, however, the example hydraulic power units shown in FIGS. 2 to 5 may optionally comprise one or both of the user interface 124 and the communication circuitry 126, and may also optionally comprise any other features described in relation to the HPU 110 shown in FIG. 1 which may have been omitted from the description of FIGS. 2 to 5.

It is to be understood that the hydraulic power units shown in FIGS. 2 to 5, and indeed the HPU 110 shown in FIG. 1, have been simplified for the sake of clarity, and any hydraulic power unit disclosed herein may comprise conventional components of hydraulic power units not shown in FIGS. 1 to 5, including but not limited to, for example: electrical power source(s); manifold(s); valve(s), including pressure relief valve(s), pressure compensating valve(s) and any other type of valve; any other conventional hydraulic componentry; and any combination thereof.

FIG. 2 schematically illustrates an example hydraulic power unit (HPU) 200 according to an embodiment of the present disclosure. The HPU 200 is operable to provide a pressurised hydraulic fluid to its outlet at a fixed target pressure by controlling a flow rate of hydraulic fluid pumped by the HPU 200. As will be discussed below, the flow rate may be controlled by controlling a fluid displacement of a pump of the HPU.

The HPU 200 comprises the electric motor 112, the pump 114, the reservoir 116, the outlet 118, the inlet 120, the motor driver circuitry 122, and a pressure sensor 210.

In the embodiment shown in FIG. 2, the motor driver circuitry 122 is arranged to provide the electrical supply 202 to the electric motor 112 via an electrical coupling therebetween.

In the embodiment shown in FIG. 2, the electric motor 112 is arranged to drive the pump 114 via a mechanical coupling therebetween, the mechanical coupling indicated by the arrow 204.

In the embodiment shown in FIG. 2, the pump 114 is arranged to receive hydraulic fluid from the reservoir 116 via a fluidic coupling therebetween, the said fluidic coupling indicated by the arrow 206. The pump 114 is further arranged to pump hydraulic fluid received from the reservoir 116 to the outlet 118 via a fluidic coupling therebetween, the said fluidic coupling indicated by the arrow 208. The inlet 120 is arranged to provide hydraulic fluid (e.g., received from a material testing apparatus such as the material testing apparatus 130) to the reservoir 116 via a fluidic coupling therebetween, as illustrated by the arrow 214.

In the embodiment shown in FIG. 2, the electric motor 112 is an AC electric motor arranged to operate at a substantially fixed (e.g. substantially constant) rotational speed and the pump 114 is operable as a pressure compensated variable displacement pump having a fixed pressure set point. The pressure sensor 210 is arranged to measure an output pressure of the HPU 200 and to provide an indication of the measured output pressure to the pump 114, as indicated by the arrow 212. The pump 114 is arranged to control its fluid displacement based on its fixed pressure set point and the received measured pressure so as to substantially maintain the output pressure at the pressure set point, in accordance with examples disclosed herein.

Advantageously, in circumstances where a flow demand at the pressure set point is particularly low, the fluid displacement of the pump 114 can be controlled to a correspondingly low value of fluid displacement. Accordingly, a load demand on the motor will decrease, thereby reducing its power consumption and the power consumption of the HPU 200. Furthermore, because the fluid displacement of the pump 114, and therefore a flow rate provided by the HPU 200 at the pressure set point, can be tailored to meet the flow demand, it may not be required to expel excess hydraulic fluid flow via, for example, a pressure relief valve, which may have associated cooling requirements having an associated energy cost.

The motor driver circuitry 122 comprises the electrical inverter discussed in relation to FIG. 1, which is arranged to control the operating point of the electric motor 112 by controlling one or more parameters of the (AC) electrical supply to be provided to the electric motor 112. In the embodiment shown in FIG. 2, the motor driver circuitry 122 comprising the electrical inverter is, in accordance with examples disclosed herein, arranged to control one or more parameters of the AC electrical supply such that the operating efficiency of the electric motor 112 is changed to maintain the operating point. For example, the motor driver circuitry 122 comprising the electrical inverter may be arranged to control one or more parameters of the AC electrical supply provided to the electric motor 112 so as to maintain the operating point and to e.g., reduce the input power, thereby increasing the operating efficiency of the electric motor 112 for that operating point. Accordingly, the HPU 200 may provide for an energy efficient HPU.

While the pressure sensor 210 and the indication of the measured output pressure 212 are shown to be external to the pump 114, this is merely one example and the present disclosure is not so limited. In other examples, the pump 114 may comprise the pressure sensor 210.

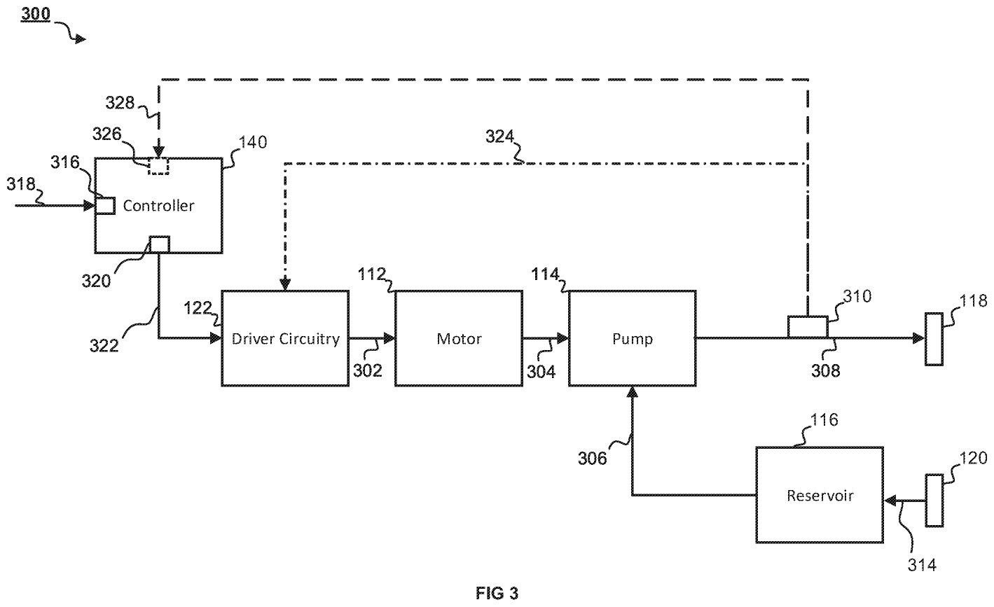

FIG. 3 schematically illustrates an example hydraulic power unit (HPU) 300 according to an embodiment of the present disclosure.

The HPU 300 comprises the electric motor 112, the pump 114, the reservoir 116, the outlet 118, the inlet 120, the motor driver circuitry 122, a pressure sensor 310, and the controller 140.

The HPU 300 is operable to provide a pressurised hydraulic fluid to its outlet at a variable target pressure by controlling a flow rate of hydraulic fluid pumped by the HPU 300. As will be discussed below, the flow rate may be controlled by controlling a rotational speed of the electric motor 112 of the HPU 300.

In the embodiment shown in FIG. 3, the electric motor 112 is arranged to operate at a variable speed and the pump 114 is operable as a positive displacement pump having a substantially fixed fluid displacement.

In the embodiment shown in FIG. 3, the motor driver circuitry 122 is arranged to provide the electrical supply 302 to the electric motor 112 via an electrical coupling therebetween.

In the embodiment shown in FIG. 3, the electric motor 112 is arranged to drive the pump 114 via a mechanical coupling therebetween, as indicated by the arrow 304.

In the embodiment shown in FIG. 3, the pump 114 is arranged to receive hydraulic fluid from the reservoir 116 via a fluidic coupling therebetween, as indicated by the arrow 306. The pump 114 is further arranged to pump hydraulic fluid received from the reservoir 116 to the outlet 118 via a fluidic coupling therebetween, as indicated by the arrow 308. The inlet 120 is arranged to provide hydraulic fluid (e.g., received from a material testing apparatus such as the material testing apparatus 130) to the reservoir 116 via a fluidic coupling therebetween, as illustrated by the arrow 314.

In the embodiment shown in FIG. 3, the controller 140 is arranged to control the rotational speed of the electric motor 112 to control the output pressure of the HPU 300 based on a pressure set point (e.g., maintain the output pressure of the HPU 300 at a target pressure, the target pressure based on the pressure set point e.g., the target pressure being equal to or greater than the pressure set point), such as, for example, a first pressure set point for performing a first material test process, and a second pressure set point for performing a second material test process, or any other pressure set point.

In the embodiment shown in FIG. 3, the controller 140 comprises an input 316 arranged to receive an indication 318 of the pressure set point (e.g., the first pressure set point for performing the first material test process or e.g., the second pressure set point for performing the second material test process). The indication 318 may be received, for example, in accordance with any example disclosed herein.

In the embodiment shown in FIG. 3, the controller 140 comprises an output 320 arranged to provide a motor control signal 322 to the motor driver circuitry 122, wherein the output 320 of the controller 140 is electrically coupled to an input of the motor driver circuitry 122 arranged to receive the motor control signal. The motor control signal 322 may be operable to control the electric motor 112 in accordance with, for example, any example disclosed herein.

With respect to the embodiment shown in FIG. 3, in some examples, as discussed in relation to the embodiment shown in FIG. 1, motor driver circuitry 122 may comprise controlling means (not shown) operable to receive an indication of a pressure set point (such as, for example, the first or second pressure set point) and to control the output pressure of the HPU 300 based on the pressure set point by controlling the rotational speed of the electric motor 112. In these examples, motor control signal 322 may comprise an indication of the pressure set point, such as the first or second pressure set point, for example. In other examples, the controller 140 may be arranged to directly control the rotational speed of the electric motor 112 to control the output pressure of the HPU 300 based on a pressure set point (such as, for example, the first or second pressure set point). In these examples, the motor control signal 322 may comprise an indication of one or more parameters of the electrical supply and the motor driver circuitry 122 may be arranged to control one or more parameters of the electrical supply in accordance with motor control signal 322.

In the embodiment shown in FIG. 3, the HPU 300 is arranged to utilise closed-loop control to maintain the output pressure of the HPU 300. The pressure sensor 310 is arranged to measure the output pressure of the HPU 300 and to provide an indication of the measured output pressure as feedback for controlling the rotational speed of the electric motor 112. In examples where the motor driver circuitry 122 comprises the above-discussed controlling means, the pressure sensor may be arranged to provide the indication of the measured output pressure to the motor driver circuitry 122, as indicated by the arrow 324. In examples where the controller 140 is arranged to control the rotational speed of the electric motor 112 directly, the pressure sensor may be arranged to provide the indication of the measured output pressure to an input 326 of the controller 140, as indicated by the arrow 328.

Advantageously, the HPU 300 provides for an HPU operable to tailor its output pressure in accordance with a pressure demand of a material test process, thereby enabling an HPU having a reduced power consumption.

With respect to the embodiment shown in FIG. 3, in some examples, the electric motor 112 may comprise an AC electric motor and the motor driver circuitry 122 may comprise an electrical inverter in accordance with examples disclosed herein. In these examples, the motor driver circuitry 122 comprising the electrical inverter may be arranged to control the operating point of the electric motor 112 by controlling one or more parameters of the (AC) electrical supply 302 such that an operating efficiency of the electric motor 112 is changed to maintain the operating point, in accordance with any example disclosed herein. Advantageously, this may enable the HPU 300 to operate yet more efficiently still.

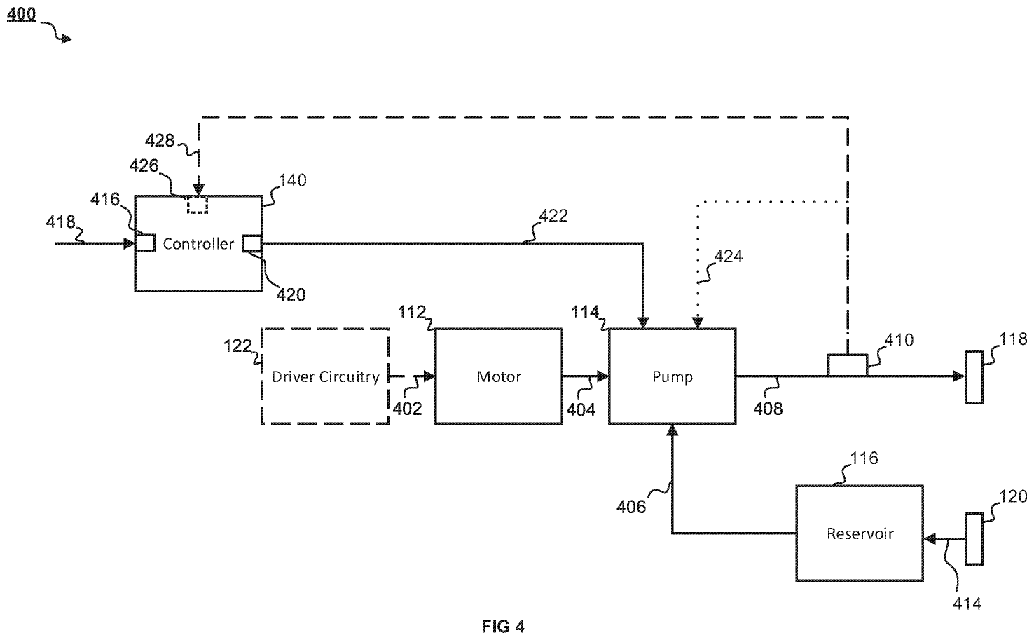

FIG. 4 schematically illustrates an example hydraulic power unit (HPU) 400 according to an embodiment of the present disclosure.

The HPU 400 comprises the electric motor 112, the pump 114, the reservoir 116, the outlet 118, the inlet 120, a pressure sensor 410, and the controller 140. Optionally, in some examples, the HPU 400 comprises the motor driver circuitry 122.

The HPU 400 is operable to provide a pressurised hydraulic fluid to its outlet at a variable target pressure by controlling a flow rate of hydraulic fluid pumped by the HPU 400. As will be discussed below, the flow rate may be controlled by controlling a fluid displacement of the pump 114 of the HPU 400.

In the embodiment shown in FIG. 4, the electric motor 112 is arranged to drive the pump 114 via a mechanical coupling therebetween, as indicated by the arrow 404.

In the embodiment shown in FIG. 4, the pump 114 is arranged to receive hydraulic fluid from the reservoir 116 via a fluid coupling therebetween, as indicated by the arrow 406. The pump 114 is further arranged to pump hydraulic fluid received from the reservoir 116 to the outlet 118 via a fluidic coupling therebetween, as indicated by the arrow 408. The inlet 120 is arranged to provide hydraulic fluid (e.g., received from a material testing apparatus such as the material testing apparatus 130) to the reservoir 116 via a fluidic coupling therebetween, as illustrated by the arrow 414.

In the embodiment shown in FIG. 4, the electric motor 112 comprises any type of electric motor, including, for example, any type of electric motor disclosed herein or any other type of electric motor.

In the embodiment shown in FIG. 4, the electric motor 112 is arranged to operate at a substantially fixed speed and the pump 114 is operable as a pressure compensated variable displacement pump having an adjustable pressure set point, in accordance with examples disclosed herein.

In the embodiment shown in FIG. 4, the controller 140 is arranged to control the output pressure of the HPU 400 based on a pressure set point (e.g., maintain the output pressure of the HPU 400 at a target pressure, the target pressure based on the pressure set point e.g., the target pressure being equal to or greater than the pressure set point), such as, for example, a first pressure set point for performing a first material test process, an second pressure set point for performing a second material test process, or any other pressure set point. In some examples, the controller 140 is arranged to control the fluid displacement of the pump 114 based on the pressure set point for performing a first material test process.

In the embodiment shown in FIG. 4, the controller 140 comprises an input 416 arranged to receive an indication 418 of the pressure set point (e.g., the first pressure set point for performing the first material test process or e.g., the second pressure set point for performing the second material test process). The indication 418 may be received, for example, in accordance with any example disclosed herein.

In the embodiment shown in FIG. 4, the controller 140 comprises an output 420 arranged to provide a pump control signal 422 to the pump 114, wherein the output 420 of the controller 140 is electrically coupled to an input of the pump 114 arranged to receive the pump control signal 422. The pump control signal 422 may be operable to control the pump 114 in accordance with, for example, any example disclosed herein.

With respect to the embodiment shown in FIG. 4, in some examples, as discussed in relation to the embodiment shown in FIG. 1, the pump 114 may comprise pressure compensating controlling means (not shown) operable to receive an indication of a pressure set point (such as, for example, the first or second pressure set point) and to control the output pressure of the HPU 400 based on the pressure set point by controlling the fluid displacement of the pump 114. In these examples, pump signal 422 may comprise an indication of the pressure set point, such as the first or second pressure set point, for example. In other examples, the controller 140 may be arranged to directly control fluid displacement of the pump 114 to control the output pressure of the HPU 400 based on the pressure set point (such as, for example, the first or second pressure set point). In these examples, the pump control signal 422 may comprise an indication of the fluid displacement of the pump 114 and the pump 114 may be arranged to control its fluid displacement in accordance with pump control signal 422.

In the embodiment shown in FIG. 4, the HPU 400 is arranged to utilise closed-loop control to maintain the output pressure of the HPU 400. The pressure sensor 410 is arranged to measure the output pressure of the HPU 400 and to provide an indication of the measured output pressure as feedback for controlling the fluid displacement of the pump 114. In examples where the pump 114 comprises the above-discussed pressure compensating controlling means, the pressure sensor 410 may be arranged to provide the indication of the measured output pressure to the pump 114, as indicated by the arrow 424. In examples where the controller 140 is arranged to control the fluid displacement of the pump directly, the pressure sensor 410 may be arranged to provide the indication of the measured output pressure to an input 426 of the controller 140, as indicated by the arrow 428.

Advantageously, the HPU 400 provides for an HPU operable to tailor its output pressure in accordance with a pressure demand of a material test process, thereby enabling an HPU having a reduced power consumption.

With respect to the embodiment shown in FIG. 4, in some examples, the electric motor 112 may comprise an AC electric motor and the HPU 400 may further comprise the motor driver circuitry 122 comprising an electrical inverter arranged to provide the (AC) electrical supply 402 to the electric motor 112 via an electrical coupling therebetween. In these examples, the motor driver circuitry 122 comprising the electrical inverter may be arranged to control the operating point of the electric motor 112 by controlling one or more parameters of the (AC) electrical supply such that an operating efficiency of the electric motor 112 is changed to maintain the operating point, in accordance with any example disclosed herein. Advantageously, this may enable the HPU 400 to operate yet more efficiently still.

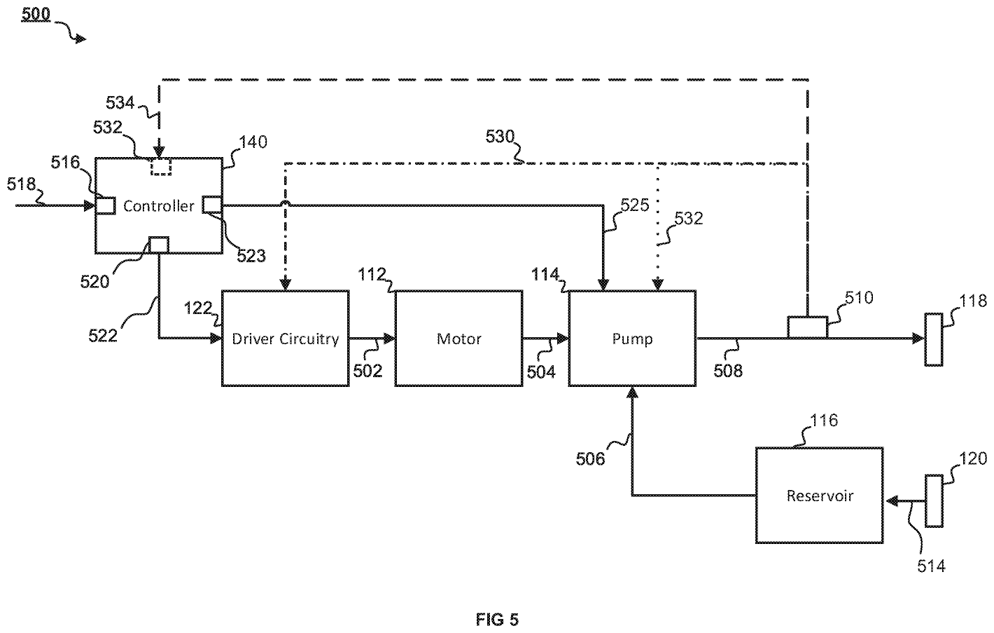

FIG. 5 schematically illustrates an example hydraulic power unit (HPU) 500 according to an embodiment of the present disclosure.

The HPU 500 comprises the electric motor 112, the pump 114, the reservoir 116, the outlet 118, the inlet 120, the motor driver circuitry 122, a pressure sensor 510, and the controller 140.

The HPU 500 is operable to provide a pressurised hydraulic fluid to its outlet at a variable target pressure by controlling a flow rate of hydraulic fluid pumped by the HPU 500. As will be discussed below, the flow rate may be controlled by controlling both a rotational speed of the electric motor 112 of the HPU 500 and the fluid displacement of the pump 114. One or both of the fluid displacement of the pump 114 and the rotational speed of the electric motor 122 may be controlled in dependence on predetermined characterisation data, such that a combined operating efficiency of the electric motor and the pump is controlled.

In the embodiment shown in FIG. 5, the electric motor is arranged to operate at a variable speed and the pump 114 is operable as a pressure compensated variable displacement pump having an adjustable pressure set point, in accordance with examples disclosed herein.

In the embodiment shown in FIG. 5, the motor driver circuitry 122 arranged to provide an electrical supply 502 to the electric motor 112 via an electrical coupling therebetween.

In the embodiment shown in FIG. 5, the electric motor 112 is arranged to drive the pump 114 via a mechanical coupling therebetween, as indicated by the arrow 504.

In the embodiment shown in FIG. 5, the pump 114 is arranged to receive hydraulic fluid from the reservoir 116 via a fluid coupling therebetween, as indicated by the arrow 506. The pump 114 is further arranged to pump hydraulic fluid received from the reservoir 116 to the outlet 118 via a fluidic coupling therebetween, as indicated by the arrow 508. The inlet 120 is arranged to provide hydraulic fluid (e.g., received from a material testing apparatus such as the material testing apparatus 130) to the reservoir 116 via a fluidic coupling therebetween, as illustrated by the arrow 514.

In the embodiment shown in FIG. 5, the controller 140 is arranged to control both the rotational speed of the electric motor 112 and the fluid displacement of the pump 114 to control the output pressure of the HPU 500 based on a pressure set point (e.g., maintain the output pressure of the HPU 500 at a target pressure, the target pressure based on the pressure set point e.g., the target pressure being equal to or greater than the pressure set point), such as, for example, a first pressure set for performing a first material test process, an second pressure set point for performing a second material test process, or any other pressure set point. In some examples, the controller 140 is arranged to control both the rotational speed of the electric motor 112 and the fluid displacement of the pump 114 based on the pressure set point.

In the embodiment shown in FIG. 5, the controller 140 comprises an input 516 arranged to receive an indication 518 of the pressure set point (e.g., the first pressure set point for performing the first material test process or e.g., the second pressure set point for performing the second material test process). The indication 518 may be received, for example, in accordance with any example disclosed herein.

In the embodiment shown in FIG. 5, the controller 140 comprises a first output 520 arranged to provide a motor control signal 522 to the motor driver circuitry 122, wherein the first output 520 of the controller 140 is electrically coupled to an input of the motor driver circuitry 122. The motor control signal 522 may be operable to control the electric motor 112 in accordance with, for example, any example disclosed herein.

In the embodiment shown in FIG. 5, the controller 140 comprises a second output 523 arranged to provide a pump control signal 525 to the pump 114, wherein the output 523 of the controller 140 is electrically coupled to an input of the pump 114. The pump control signal 525 may be operable to control the pump 114 in accordance with, for example, any example disclosed herein.

With respect to the embodiment shown in FIG. 5, in some examples, as discussed in relation to the embodiment shown in FIG. 1, the motor driver circuitry 122 may comprise controlling means (not shown) operable to receive an indication of a pressure set point (such as, for example, the first or second pressure set point) and to control the output pressure of the HPU 500 based on the pressure set point by controlling the rotational speed of the electric motor 112. In these examples, motor control signal 522 may comprise an indication of the pressure set point, such as the first or second pressure set point, for example. In other examples, the controller 140 may be arranged to directly control the rotational speed of the electric motor 112 to control the output pressure of the HPU 500 based on the pressure set point (such as, for example, the first or second pressure set point). In these examples, the motor control signal 522 may comprise an indication of one or more parameters of the electrical supply and the motor driver circuitry 122 may be arranged to control one or more parameters of the electrical supply in accordance with motor control signal 522.

With respect to the embodiment shown in FIG. 5, in some examples, as discussed in relation to the embodiment shown in FIG. 1, the pump 114 may comprise pressure compensating controlling means (not shown) operable to receive an indication of a pressure set point (such as, for example, the first or second pressure set point) and to control the output pressure of the HPU 500 based on the pressure set point by controlling the fluid displacement of the pump 114. In these examples, the pump control signal 525 may comprise an indication of the pressure set point, such as the first or second pressure set point, for example. In other examples, the controller 140 may be arranged to directly control fluid displacement of the pump 114 to control the output pressure of the HPU 500 based on the pressure set point (such as, for example, the first or second pressure set point). In these examples, the pump control signal 525 may comprise an indication of the fluid displacement of the pump 114 and the pump 114 may be arranged to control its fluid displacement in accordance with pump control signal 525.

In the embodiment shown in FIG. 5, the HPU 500 is arranged to utilise closed-loop control to maintain the output pressure of the HPU 500. The pressure sensor 510 is arranged to measure the output pressure of the HPU 500 and to provide an indication of the measured output pressure as feedback for controlling both the rotational speed of the electric motor 112 and the fluid displacement of the pump 114.

In examples where the motor driver circuitry 122 comprises the above-discussed controlling means, the pressure sensor 510 may be arranged to provide the indication of the measured output pressure to the motor driver circuitry 122, as indicated by the arrow 530.

In examples where the pump 114 comprises the above-discussed pressure compensating controlling means, the pressure sensor 510 may be arranged to provide the indication of the measured output pressure to the pump 114, as indicated by the arrow 532.

In examples where the controller 140 is arranged to control one or both of the rotational speed of the electric motor 112 directly and the fluid displacement of the pump 114 directly, the pressure sensor 510 may be arranged to provide the indication of the measured output pressure to an input 532 of the controller 140, as indicated by the arrow 534.

Advantageously, the HPU 500 provides for an HPU operable to tailor its output pressure in accordance with a pressure demand of a material test process, thereby enabling an HPU having a reduced power consumption.

In some examples, the controller 140 may be arranged to control both the rotational speed of the electric motor 112 (e.g., via the motor control signal 522) and the fluid displacement of the pump 114 (e.g., via the pump control signal 525) to control the output pressure of the HPU 110 based on the pressure set point, wherein the controller 140 is arranged to control one or both of the fluid displacement of the pump 114 and the rotational speed of the electric motor 112 in dependence on predetermined characterisation data, such that a combined operating efficiency of the electric motor 112 and the pump 114 is controlled, in accordance with any example disclosed herein. Advantageously, this may enable the HPU 500 to operate yet more efficiently still.

With respect to the embodiment shown in FIG. 5, in some examples, the electric motor 112 may comprise an AC electric motor and the motor driver circuitry 122 may comprise an electrical inverter arranged to provide the (AC) electrical supply 502 to the electric motor 112. In these examples, the motor driver circuitry 122 comprising the electrical inverter may be arranged to control the operating point of the electric motor 112 by controlling one or more parameters of the (AC) electrical supply such that an operating efficiency of the electric motor 112 is changed to maintain the operating point, in accordance with any example disclosed herein. Advantageously, this may yet further improve the efficiency of the HPU 500.

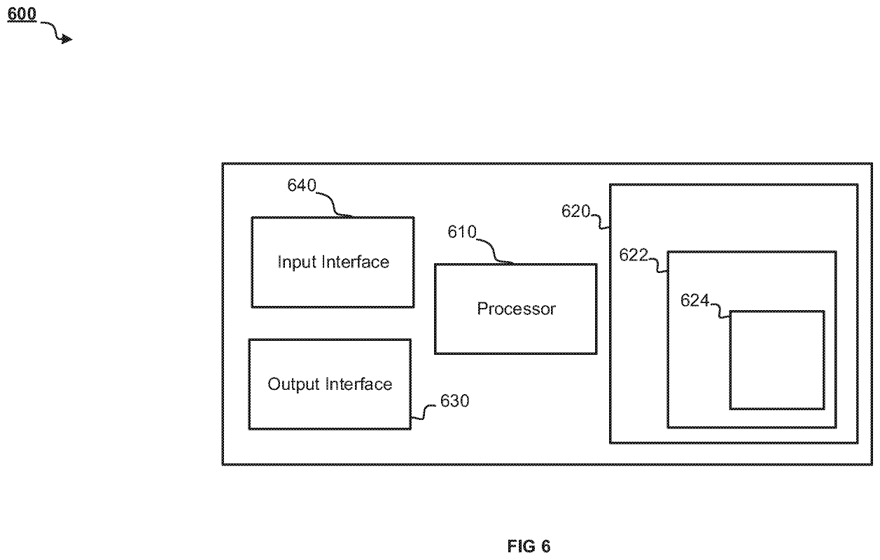

FIG. 6 schematically illustrates an apparatus 600 in accordance with various embodiments of the present disclosure. In some examples, the apparatus 600 may correspond to, for example, a controller, such as, for example, the controller 140. In some examples, the apparatus 600 may correspond to the load determiner 142.

As shown in FIG. 6, the apparatus 600 may be implemented by a processor 610 and a memory 620 including a computer program 622 comprising computer program instructions 624. The apparatus 600 may comprise an output interface 630, which may be comprised within the processor 610 or operably coupled thereto, via which data and/or commands in the form of control signals are output by the processor 610. The apparatus 600 may comprise and an input interface 640, which may be comprised within the processor 610 or operably coupled thereto, via which data and/or commands are input to the processor 610. Implementation of the apparatus 600 can be in hardware alone (a circuit), have certain aspects in software including firmware alone or can be a combination of hardware and software (including firmware). The computer program 622 may be stored on a (e.g., non-transitory) computer readable storage medium (disk, memory etc). The computer program 622 may be computer software which, when executed, i.e. by the processor 610 is arranged to perform a method according to the method described below in relation to one or more of FIGS. 7 and 8.

FIG. 7 depicts an example flowchart 700 schematically illustrating controlling a hydraulic power unit in accordance with an embodiment of the present disclosure. The hydraulic power unit may comprise, for example, any one of the hydraulic power unit 110, the hydraulic power unit 300, the hydraulic power unit 400, and the hydraulic power unit 500. Flowchart 700 may be performed by, for example, a controller operable to control a hydraulic power unit, such as, for example, the controller 140.

At block 710, a pressure of a pressurised hydraulic fluid to be provided to a material testing apparatus is controlled based on a first pressure set point for performing a first material test process. The controlling of the pressurised hydraulic fluid based on the first pressure set point may be in accordance with any example disclosed herein.

At block 720, an indication of a second pressure set point for a second material test process to be performed by the material testing apparatus is received. The receiving of the indication of the second pressure set point may be in accordance with any example disclosed herein.

At block 730, the pressure of the pressurised hydraulic fluid to be provided to the material testing apparatus is controlled based on the second pressure set point. The controlling of the pressurised hydraulic fluid based on the second pressure set point may be in accordance with any example disclosed herein.

FIG. 8 depicts an example flowchart schematically illustrating a method in accordance with the present disclosure.

At block 810, an indication of a test configuration of a test process to be performed by a material testing apparatus is obtained, the material testing apparatus arranged to receive a pressurised hydraulic fluid from a hydraulic power unit, HPU. The material testing apparatus may correspond to, for example, the material testing apparatus 130 or any other material testing apparatus. The hydraulic power unit may comprise, for example, any one of the hydraulic power unit 110, the hydraulic power unit 300, the hydraulic power unit 400, and the hydraulic power unit 500. The material test process may correspond to, for example, any material test process including any material test process disclosed herein. The indication of the test configuration may be obtained in accordance with any example disclosed herein.

At bock 820, a load demand of the test process may be determined based on the received indication of the test configuration. The load demand may be determined in accordance with any example disclosed herein.

At block 830, an indication of a pressure set point is provided to a controller based on the determined load demand, the controller being arranged to control a pressure of the pressurised hydraulic fluid for performing the material test process. The controller may correspond to, for example, the controller 140. The indication may be provided to the controller in accordance with any examples disclosed herein.

It will be appreciated that embodiments of the present disclosure can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present disclosure. Accordingly, embodiments provide a program comprising code for implementing a system or method as claimed in any preceding claim and a machine readable storage storing such a program. Still further, embodiments of the present disclosure may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A hydraulic power unit (HPU), for providing a pressurised hydraulic fluid to a material testing apparatus, the HPU comprising:
a reservoir for storing a hydraulic fluid;
a pump for pumping the hydraulic fluid to an outlet connectable to the material testing apparatus;
an alternating current, AC, electric motor arranged to drive the pump, wherein the electric motor is located within the reservoir; and
an electrical inverter for providing an AC electrical supply to the electric motor, wherein the electrical inverter is arranged to control an operating point of the electric motor.

2. The HPU of claim 1, wherein the HPU is arranged to provide the hydraulic fluid to the outlet at a target pressure.

3. The HPU of claim 2, wherein the target pressure is set based on a received signal.

4. The HPU of claim 1, wherein the electrical inverter is arranged to control the operating point of the electric motor by controlling any one or more of: a voltage of the AC electrical supply; a current of the AC electrical supply; a frequency of the AC electrical supply; and a phase of the AC electrical supply.

5. The HPU of claim 4, wherein the electrical inverter is arranged to control the operating point of the electric motor by controlling one or more of the current of the AC electrical supply, the frequency of the AC electrical supply, and the phase of the AC electrical supply such that an operating efficiency of the electric motor is changed to maintain the operating point.

6. The HPU of claim 1, wherein the pump is a variable displacement pump to control a flow rate of the hydraulic fluid from the outlet.

7. The HPU of claim 1, further comprising a controller arranged to control a rotational speed of the electric motor to maintain the hydraulic fluid at the outlet at the target pressure.

8. The HPU of claim 7, wherein the controller is arranged to control a fluid displacement of the pump to maintain the hydraulic fluid at the outlet at the target pressure.

9. The HPU of claim 7, wherein the pump is operable as a pressure compensated variable displacement pump having an adjustable pressure set point, the controller being arranged to control the fluid displacement of the pump by controlling the said adjustable pressure set point.

10. The hydraulic power unit of claim 7, wherein the controller is arranged to control both the speed of the electric motor and the fluid displacement of the pump;
wherein one or both of the fluid displacement of the pump and the rotational speed of the electric motor are controlled in dependence on predetermined characterisation data, such that a combined operating efficiency of the electric motor and the pump is controlled.

11. The hydraulic power unit of claim 10, where the controller is arranged to:
determine a flow rate of hydraulic fluid flowing through the pump and control one or both of the fluid displacement of the pump and the rotational speed of the electric motor in dependence thereon;
wherein the predetermined characterisation data is indicative of one or both of a target fluid displacement of the pump and a target rotational speed of the electric motor depending on the said flow rate.

12. The hydraulic power unit of claim 11, wherein the controller is arranged to:
control the fluid displacement of the pump based on the target fluid displacement; or
control the rotational speed of the electric motor based on the target rotational speed.

13. The hydraulic power unit of claim 1, wherein the electric motor is arranged to be, in use, submerged within the hydraulic fluid within the reservoir.

14. The hydraulic power unit of claim 1, wherein the pump is located within the reservoir, and wherein the pump is arranged to be, in use, submerged within the hydraulic fluid within the reservoir.

15. A system comprising:
the HPU of claim 1; and
a material testing apparatus arranged to receive a pressurised hydraulic fluid from the HPU.
